(19) United States
(12) Patent Application Publication
(10) Pub. No.: US 2005/0084609 A1
(43) Pub. Date: Apr. 21, 2005

(54) Method of plating cylinder of internal combustion engine and plating apparatus

(75) Inventors: Masaharu Kocha, Saitama (JP); Takayuki Matsumoto, Yokohama-shi (JP)

Correspondence Address: BAKER & BOTTS, 30 ROCKEFELLER PLAZA, NEW YORK, NY, 10112, US

(73) Assignee: Kioritz Corporation, Tokyo (JP)

(21) Appl. No.: 10/813,883

(22) Filed: Mar. 31, 2004

(30) Foreign Application Priority Data
Oct. 15, 2003 (JP) 2003-355555

(51) Int. Cl. B05D 7/22

(52) U.S. Cl. 427/239; 427/230; 427/443.1

(57) ABSTRACT

There are provided a method and an apparatus for applying electroless plating to the cylinder of an internal combustion engine, which are capable of applying the plating exclusively to the portion where the plating is essentially required, thereby making it possible to save the plating solution and to reduce the cost for the metal plating. The plating apparatus is capable of applying electroless plating to the inner surface of the cylinder having a through-hole at the head portion thereof and is constituted by: clamping means for holding the cylinder in a predetermined posture; plating solution-introducing means for introducing a plating solution into the cylinder; and plating solution-circulating means for filling the interior of the cylinder with the plating solution introduced by the plating solution-introducing means while enabling the plating solution to pass along the axial line and through the interior of the cylinder to thereby apply the plating to the inner surface of the cylinder.

### BACKGROUND OF THE INVENTION

1. Field of the Invention

The present invention relates to a method of applying electroless plating to the inner circumferential surface of the piston-sliding surface of the cylinder of a small air-cooled two-stroke internal combustion engine which is designed to be employed in a portable power working machine. The present invention relates also to a plating apparatus for carrying out the aforementioned method.

2. Description of the Related Art

The cylinder of a small air-cooled two-stroke internal combustion engine which is designed to be employed in a portable power working machine is generally manufactured by way of casting such as a high-pressure die casting using an aluminum alloy as a matrix material, and the inner circumferential surface of the cylinder constituting a piston-sliding surface is subsequently metal-plated so as to enhance the slidability and abrasion resistance thereof.

As for the method of plating the inner circumferential surface of the cylinder, there has been conventionally known, as shown in JP Laid-open Patent Publication (Kokai) No.2001-193550 (pages 1-7, FIGS. 1-3), a method wherein electrolytic plating of the inner circumferential surface of the cylinder is performed under the conditions that a cylindrical electrode is inserted into the cylinder and that a plating solution is introduced via the interior of the cylindrical electrode into the cylinder and allowed to overflow from the cylinder, thus permitting the plating solution to pass downward between the circumferential surface and the cylindrical electrode.

However, according to this electrolytic plating, since it is required to pass an electric current between the cylinder and the cylindrical electrode which is inserted into the cylinder, the construction of the apparatus for performing the electrolytic plating is rather complicated. Furthermore, a means for controlling the flow rate of plating solution as well as a means for controlling the electric current to be applied to the cylindrical electrode are required to be installed in order to obtain a plated layer of a predetermined thickness, all of these requirements resulting in a cause for increasing the manufacturing cost of the cylinder.

Under the circumstances, applying metal plating to the inner circumferential surface by way of electroless (non-electrolytic) plating in place of the aforementioned electrolytic plating has now been studied.

FIG. 3 shows, as one example, the features of applying electroless plating to the cylinder of the internal combustion engine. The cylinder 1 shown in FIG. 3 is made of an aluminum alloy and constituted by an integral body consisting mainly of a body portion 2, and a head portion 3 having a squishy dome-shaped combustion chamber 4 formed therein, the integral body being manufactured by way of a high-pressure die casting method. Further, the cylinder 1 is provided, on the outer circumferential wall thereof, with a large number of cooling fins 19 each being protruded from the aforementioned outer circumferential wall. The head portion 3 is provided with a through-hole functioning as an ignition plug-mounting hole (internal thread) 18.

The body portion 2 is provided on the inner circumferential surface 9 thereof where the piston of the engine is slidably contacted (or the inner surface of cylinder bore), with an inlet port 5 of air-fuel mixture and also with an exhaust port 6, both of which are designed to be closed or opened by the movement of the piston 15, these inlet port 5 and exhaust port 6 being disposed to face each other in an off-set manner so that they are at a different level from each other. Furthermore, the main body 2 is also provided with a pair of scavenging passageways (scavenging ports) 7 and 8, both of which are respectively displaced away, along the circumferential direction of the cylinder bore 9, from the inlet port 5 and exhaust port 6 by an angle of about 90 degrees.

As shown in FIG. 3, on the occasion of applying electroless plating to the inner circumferential surface of the cylinder 1, the cylinder 1 is dipped in its entirety into a plating solution 10 stored in a tank 21 for a predetermined period of time. As for the non-electrolytic plating solution 10 to be employed in this case, a nickel (Ni)-phosphorus (P)-boron (B)-based plating solution (Kaniboron (trademark) available from Nippon Kanizen Co., Ltd.) can be employed. As for the period of time for dipping the cylinder 1, it can be determined depending on the thickness of the plated layer which is desired to be obtained. For example, if the layer thickness desired to be obtained is 10 μm, a dipping time of about 40 minutes would be required. The cylinder 1 is kept in a predetermined posture as it is being dipped in the plating solution 10. In this case, the plating solution 10 is maintained at a predetermined working temperature (for example, 80° C.) and may be agitated as required.

Meanwhile, JP Laid-open Patent Publication (Kokai) No.8-319576 (1996) (pages 1-7, FIGS. 1-2) discloses a method of applying electroless plating to the inner wall of an elongated heavy tube, wherein the elongated tube is held horizontally and kept rotating, and a plating solution is forcedly fed into the rotating elongated tube.

However, the conventional electroless plating method as shown in FIG. 3 wherein the cylinder is dipped in its entirety into a plating solution is accompanied with problems that the outer surface of the cylinder portions such as the fins where the application of metal plating is not essentially required is also deposited with a plated layer, so that the plating solution is wasted (namely, the plating solution would be consumed several to about ten times as much as the case where only the inner circumferential surface of the cylinder is applied with plating). At the same time, the deterioration of the plating solution would be accelerated, thereby increasing the cost for metal-plating the cylinder.

The aforementioned method of applying electroless plating to an elongated tube, which is disclosed in JP Laid-open Patent Publication (Kokai) No.8-319576 (1996), may be applicable to the metal plating of the inner circumferential surface of the cylinder of an internal combustion engine. According to this method however, a mechanism for rotating a work (such as an elongated tube, a cylinder, etc.) is required, thus rendering this method expensive in installing the plating apparatus.

### BRIEF SUMMARY OF THE INVENTION

The present invention has been made in view of the aforementioned circumstances, and therefore one of the objects of the present invention is to provide a method of applying electroless plating to the cylinder of a small air-cooled two-stroke internal combustion engine, the method being capable of adequately applying electroless plating exclusively to the portion where the plating is essentially required such as the inner circumferential surface or the piston-sliding surface of the cylinder, and also capable of performing the electroless plating without necessitating the employment of a cylindrical electrode or a cylinder-rotating mechanism, thereby making it possible to save the plating solution and to reduce the cost for the metal plating. Another object of the present invention is to provide a plating apparatus for carrying out the aforementioned method.

With a view to realize the aforementioned objects, the present invention provides a method of applying metal plating to a cylinder of an internal combustion engine, the method being featured in that the cylinder is filled with a plating solution, which is then permitted to pass through and along the axial line of the cylinder, thereby permitting a layer of electroless plating to be deposited on an inner circumferential surface of the cylinder.

According to a preferable embodiment, the cylinder is held in such a manner that the axial line of the cylinder having a through-hole formed on the head portion thereof is aligned parallel with the vertical line, and the plating solution is introduced from an opening provided at the bottom of the cylinder so as to fill the cylinder with the plating solution and then, the plating solution is permitted to flow out of the cylinder through the through-hole.

According to another preferable embodiment, a predetermined quantity of the plating solution is introduced from a main tank into a subtank disposed over the cylinder and then, the plating solution is permitted to gravitationally drop into the cylinder from the subtank, thereby filling the cylinder with the plating solution, the plating solution being subsequently permitted to pass through the interior of the cylinder and to return to the main tank.

According to another preferable embodiment, the plating solution is pumped up by means of a pump and introduced into the cylinder, thereby filling the cylinder with the plating solution, the plating solution being subsequently permitted to pass through the interior of the cylinder and to return to the main tank.

As for the electroless plating solution to be employed in the method of plating the cylinder according to the present invention, it is preferable to employ a nickel (Ni)-phosphorus (P)-boron (B)-based plating solution.

The plating apparatus according to the present invention is designed such that it is capable of applying electroless plating to the inner circumferential surface of the cylinder of an internal combustion engine, the cylinder having a through-hole at the head portion thereof, and that it comprises clamping means for holding the cylinder in a predetermined posture; plating solution-introducing means for introducing a plating solution into the cylinder; and plating solution-circulating means for filling the interior of the cylinder with the plating solution introduced by the plating solution-introducing means while enabling the plating solution to pass through the interior of the cylinder at a predetermined flow rate.

Preferably, the clamping means is designed to hold the cylinder in such a manner that the axial line of the cylinder is aligned parallel with the vertical line.

In a preferable embodiment, the plating solution-introducing means is provided with a subtank which is disposed over the cylinder and designed to temporarily store the plating solution.

In another preferable embodiment, the plating solution-introducing means is provided with a pump for directly introducing the plating solution into the cylinder.

The plating solution-circulating means according to a preferable embodiment is constituted by a flow rate-adjusting nozzle which is disposed so as to the through-hole. The plating solution-circulating means according to another preferable embodiment is constituted by a flow rate-adjusting valve which is designed to adjust the flow rate of the plating solution which is being discharged out of the cylinder after passing through the interior of the cylinder.

In a further preferable embodiment, the plating apparatus is further provided with a cap member for closing an outer opening of an inlet port of air-fuel mixture formed in an inner circumferential surface or a piston-sliding surface of the cylinder and also with a cap member for closing an outer opening of an exhaust port formed in the inner circumferential surface of the cylinder.

In this case, as a preferable embodiment, the cap members are respectively provided with a flow rate-adjusting hole for permitting the plating solution to flow out of the cylinder through the inlet port and/or the exhaust port.

In a further preferable embodiment, the plating apparatus is further provided with heating means for heating the cylinder as well as the plating solution up to a predetermined working temperature.

According to the method and apparatus of the present invention for applying metal plating to the cylinder of an internal combustion engine, electroless plating is performed in such a manner that the cylinder is preferably held in such a posture that the axial line thereof is made parallel with the vertical line or vertically held (the head portion of the cylinder may be disposed either the upper side or the lower side) and that the plating solution is permitted to pass through the cylinder bore in the direction along the axial line of the cylinder while filling the cylinder bore with the plating solution, thereby enabling the electroless plating to take place in the inner circumferential surface of the cylinder. As a result, the electroless plating can be adequately applied exclusively to the portion where the plating is essentially required such as the inner circumferential surface or the piston-sliding surface of the cylinder. Therefore, it is now possible to perform the electroless plating without necessitating the employment of a cylindrical electrode or a cylinder-rotating mechanism, thereby making it possible to save the plating solution and to reduce the cost for the metal plating.

In this case, the thickness of non-electrolytically deposited layer is determined depending on the flow rate and flowing velocity of the plating solution passing through the cylinder bore. Therefore, if the flow rate of the plating solution to be fed into the cylinder as well as the flowing velocity of the plating solution to be discharged from the cylinder (more specifically, the inner diameter of the flow rate-adjusting nozzle which constitutes the plating solution circulating means and the like) are set in advance so as to obtain a desired thickness of non-electrolytically deposited layer, it is possible to relatively easily perform the electroless plating of desired layer thickness without necessitating any other manipulations (such as the manipulation of rotating the cylinder or the manipulation of agitating the plating solution).

If the outer openings of the inlet port and exhaust port attached to the cylinder are respectively closed by a cap member, the interiors of the inlet port and the exhaust port can be also filled with the plating solution, and at the same time, the flow of the plating solution that has been altered in flowing direction in the interiors of the inlet port and exhaust port may be lowered in flowing velocity as compared with the flowing velocity of the plating solution flowing along the inner circumferential surface of the cylinder (through the cylinder bore), thereby realizing the deposition of a plated layer having a thickness smaller than the layer thickness of non-electrolytically deposited layer formed on the inner circumferential surface of the cylinder. When the metal plating is applied also to the inner surfaces of the inlet port, exhaust port and scavenging passageway, the flow resistance thereof to the in-take air-fuel mixture and exhaust gas can be alleviated, thereby improving the performance of engine. In this case, since the thickness of the plated layer to be deposited on the inner walls of the inlet port and exhaust port is only required to be very thin, it is possible to form a plated layer of desired thickness without necessitating any particular manipulation. When a flow rate-adjusting hole having a suitable sectional area of passageway for discharging the plating solution through the inlet port and exhaust port is formed in each of the cap members, the thickness of the plated layer to be deposited on the inner walls of the inlet port and exhaust port can be optionally altered.

### BRIEF DESCRIPTION OF THE SEVERAL VIEWS OF THE DRAWING

FIG. 1 is a partially cut-out cross-sectional view of a cylinder of an internal combustion engine, schematically illustrating a state wherein electroless plating is being performed on the inner circumferential surface of the cylinder according to one exemplary embodiment of the plating apparatus of the present invention;

FIG. 2 is a partially cut-out cross-sectional view of a cylinder of an internal combustion engine, schematically illustrating a state wherein electroless plating is being performed on the inner circumferential surface of the cylinder according to another exemplary embodiment of the plating apparatus of the present invention; and

FIG. 3 is a cross-sectional view of a cylinder of an internal combustion engine, schematically illustrating a state wherein electroless plating is being performed on the inner circumferential surface of the cylinder according to the conventional dipping method.

### DETAILED DESCRIPTION OF THE INVENTION

The specific embodiments of the present invention will be explained below with reference to drawings.

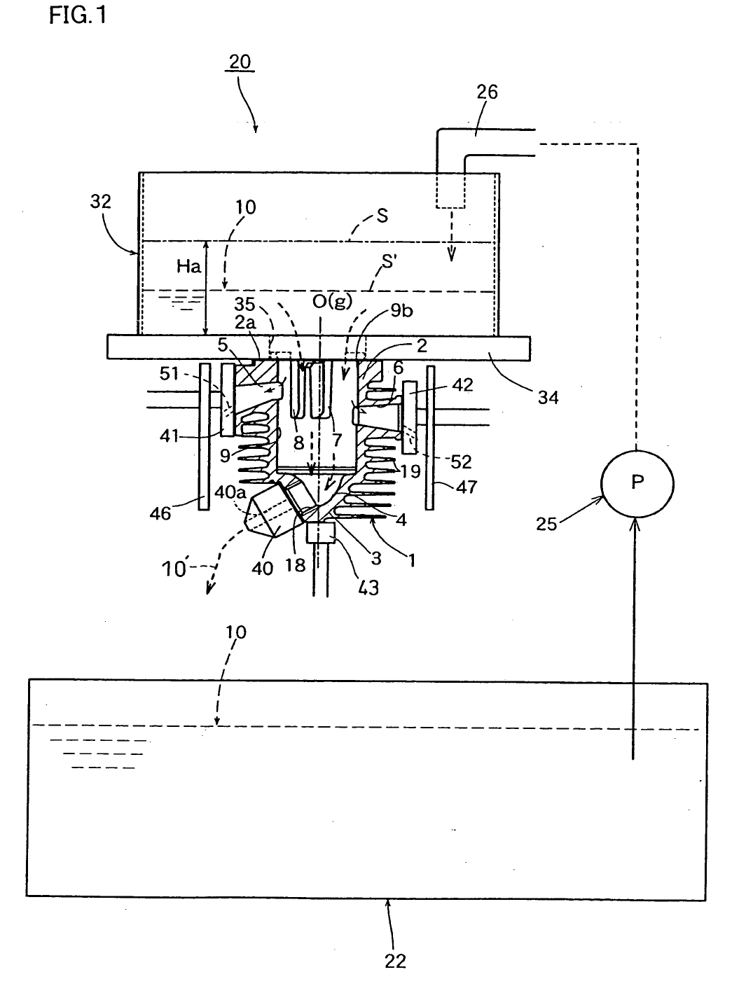

FIG. 1 shows a state where the electroless plating of the cylinder of an internal combustion engine is being performed according to one exemplary embodiment of the plating apparatus of the present invention.

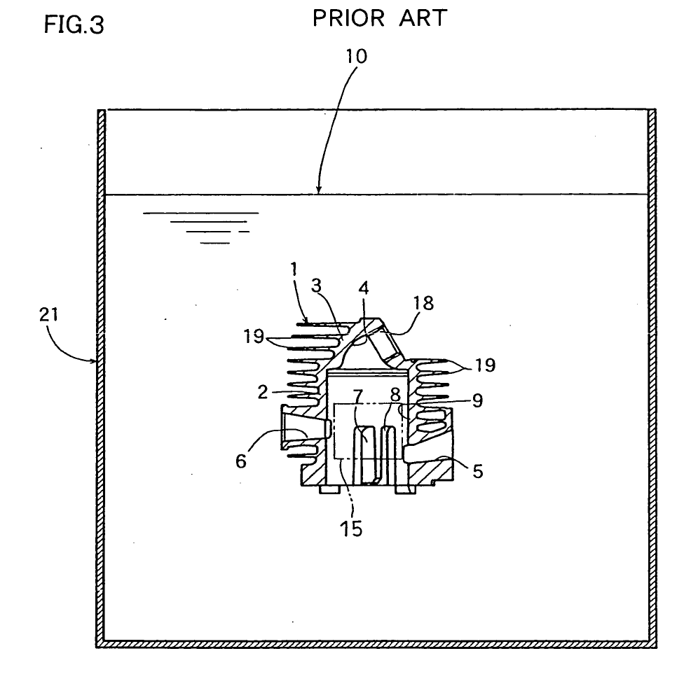

The cylinder 1 to which the plating according to this embodiment is to be applied is of the same structure as that shown in FIG. 3 mentioned above. The plating apparatus 20 according to this embodiment is designed such that the electroless plating can be applied to the entire inner surface of the cylinder 1, i.e. the inner circumferential surface 9 thereof or the piston sliding surface (the inner surface of cylinder bore), the inner surface of the combustion chamber 4, the inner surfaces of a pair of scavenging passageways 7 and 8 which are disposed to face each other, the inner surface of an inlet port 5 and the inner surface of an exhaust port 6.

The non-electrolytic plating solution 10 to be employed in this embodiment is formed of the same kind as described above, i.e. a nickel (Ni)-phosphorus (P)-boron (B)-based plating solution (Kaniboron (trademark) available from Nippon Kanizen Co., Ltd.)

The plating apparatus 20 comprises a combination of clamping members 41, 42 and 43 for holding the cylinder 1 in such a posture that the axial line “O” thereof is made parallel with the vertical line “g”, i.e. the cylinder 1 is vertically turned upside down wherein the head portion (combustion chamber 4) thereof is positioned on the lower side and the bottom surface 2a thereof is positioned on the upper side; a main tank 22 for storing the plating solution 10; plating solution-introducing means constituted by a combination of a pump 25, an introducing passageway 26 and a subtank 32 for introducing the plating solution 10 from the main tank 22 into the cylinder 1; and flow rate-adjusting nozzle 40 functioning as plating solution circulating means for filling the interior of the cylinder 1 with the plating solution 10 to be discharged from the subtank 32 while enabling the plating solution 10 to pass through the interior of the cylinder 1 at a predetermined flow rate.

The clamping member 41 disposed on the inlet port side of the cylinder 1 is designed to be pressed against the outer opening of the inlet port 5 so as to act also as a cap member for closing the inlet port 5. On the other hand, the clamping member 42 disposed on the exhaust port side of the cylinder 1 is designed to be pressed against the outer opening of the exhaust port 6 so as to act also as a cap member for closing the exhaust port 6. The clamping member 43 disposed close to the head portion of the cylinder 1 is designed to be pressed against the head portion 3 of the cylinder 1.

In this embodiment, the electroless plating is designed to be performed on a plurality of cylinders 1 at a time, for example, ten pieces of cylinders 1 at a time. Therefore, concomitant with such an electroless plating, ten groups of the combination of the clamping members 41, 42 and 43 are prepared, and at the same time, a single body of the subtank 32 is horizontally arranged all over the bottom surfaces 2a of these cylinders 1 which have been positioned side by side and held respectively by these combinations of the clamping members 41, 42 and 43.

The subtank 32 is designed so as to temporarily store a predetermined volume of the plating solution which is sufficient enough for the metal plating of these ten cylinders 1. More specifically, the subtank 32 is formed of an elongated box-like configuration extended back and forth in FIG. 1, and the bottom plate 34 of the subtank 32 is provided with ten inlet ports 35 for introducing the plating solution 10 into each of the cylinders 1 through the bottom openings 9b of the cylinders 1.

The flow rate-adjusting nozzle 40 is disposed so as to plug an ignition plug-mounting hole (internal thread) 18 which is formed as a though-hole in each of the cylinders 1.

Further, the clamping members 41 and 42 disposed opposite to each other are provided with electric heaters 46 and 47, respectively, each acting as heating means for heating each of the cylinders 1 and the plating solution up to a predetermined working temperature (for example, about 80° C.) and for maintaining them at this working temperature. It is also possible to employ, as an alternative heating means, a hot air of predetermined temperature, which can be blown against the external circumferential surface of the cylinder 1.

On the occasion of performing electroless plating on the inner circumferential surface of the cylinder 1 by making use of the plating apparatus 20 according to this embodiment which has been constructed as explained above, the nozzle 40a of each of the flow rate-adjusting nozzles 40 may be closed as required, and under this condition, the plating solution 10 is introduced from the main tank 22 into the subtank 32 through the operation of the pump 25. As a result, the plating solution 10 is permitted to drop gravitationally into the cylinder 1 through each of the inlet ports 35, thereby filling the cylinder 1 with the plating solution 10. Furthermore, the subtank 32 is also filled gradually with the plating solution 10 as the top level of the plating solution 10 filling the cylinder 1 is further raised from the bottom side of the subtank 32. When a predetermined quantity of the plating solution 10 which is required for accomplishing the metal plating of ten pieces of the cylinders 1 has been introduced into the subtank 32, the top level (S) of the plating solution reaches to a predetermined height (Ha) and then, the operation of the pump “P” is stopped at this moment. Namely, the plating solution 10 is introduced into the subtank 32 until the top level(s) of the plating solution 10 reaches to the height (Ha) in the subtank 32.

Subsequently, the nozzle 40a of the flow rate-adjusting nozzles 40 is opened so as to permit the plating solution 10 stored in the cylinder 1 to flow out of the cylinder 1 and to return back to the main tank 22. At the same time, the plating solution 10 is permitted to pass along the vertical line “g” and through the cylinder bore, thereby allowing a layer of electroless plating to deposit on the inner circumferential surface 9 of the cylinder 1.

As explained above, according to the plating method and the plating apparatus 20 of this embodiment, since the cylinder 1 is held in such a posture that the axial line “O” thereof is made parallel with the vertical line “g”, i.e. the cylinder 1 is vertically turned upside down wherein the head portion 3 thereof is positioned on the lower side, and under this condition, the cylinder bore is filled with the plating solution and the plating solution is permitted to flow along the axial line “0” of the cylinder 1 and to pass through the cylinder bore so as to allow a layer of electroless plating to deposit on the inner circumferential surface 9 of the cylinder 1, it is now possible to properly apply electroless plating exclusively to the portion where the plating is essentially required such as the inner circumferential surface 9 or the piston-sliding surface of the cylinder 1. As a result, it is now possible to perform the electroless plating without necessitating the employment of a cylindrical electrode or a cylinder-rotating mechanism, thereby making it possible to save the plating solution and to reduce the cost for the metal plating.

In this case, since the thickness of non-electrolytically deposited layer is determined depending on the flow rate and flowing velocity of the plating solution 10 passing through the cylinder 1, if the flow rate of the plating solution 10 to be fed into the cylinder 1 as well as the flowing velocity of the plating solution 10 to be discharged from the cylinder 1 (more specifically, the inner diameter of the flow rate-adjusting nozzle 40 which constitutes the plating solution circulating means and the like) are set in advance so as to obtain a desired thickness of non-electrolytically deposited layer, it is possible to relatively easily perform the electroless plating of desired layer thickness without necessitating any other manipulations (such as the manipulation of rotating the cylinder or the manipulation of agitating the plating solution).

Further, if the outer openings of the inlet port 5 and exhaust port 6 attached to the cylinder 1 are respectively closed by the clamping members 41 and 42 functioning also as a cap member, the interiors of the inlet port 5 and exhaust port 6 can be also filled with the plating solution 10, and at the same time, the flow of the plating solution 10 that has been altered in flowing direction in the interiors of the inlet port 5 and exhaust port 6 may be lowered in flowing velocity as compared with the flowing velocity of the plating solution 10 flowing along the inner circumferential surface 9 of the cylinder 1 (through the cylinder bore), thereby realizing the deposition of a plated layer having a thickness smaller than the layer thickness of non-electrolytically deposited layer formed on the inner circumferential surface 9 of the cylinder 1. Moreover, when the metal plating is applied also to the inner surfaces of the inlet port 5, exhaust port 6 and the scavenging passageways 7 and 8, the flow resistance thereof to the in-take air-fuel mixture and exhaust gas can be alleviated, thereby improving the performance of engine. In this case, since the thickness of the plated layer to be deposited on the inner walls of the inlet port 5 and exhaust port 6 is only required to be very thin, it is possible to form a plated layer of desired thickness without necessitating any particular manipulation. When flow rate-adjusting holes 51 and 52 each having a suitable sectional area of passageway for discharging the plating solution 10 through the inlet port 5 and exhaust port 6 are formed respectively in the clamping members 41 and 42 each functioning also as a cap member, the thickness of the plated layer to be deposited on the inner walls of the inlet port 5 and exhaust port 6 can be optionally altered.

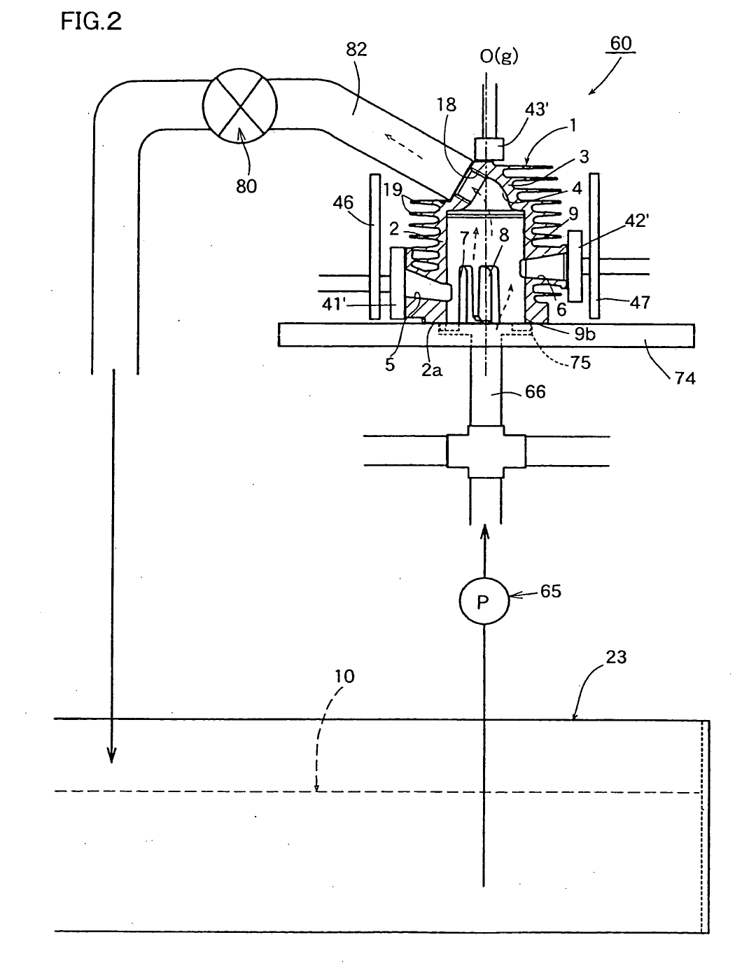

FIG. 2 shows a state where the electroless plating of the cylinder 1 of internal combustion engine is being performed according to another embodiment of the plating apparatus of the present invention.

In the plating apparatus 60 of this embodiment, the cylinder 1 is held in an erected state parallel with the vertical line “g” by means of a holding plate 74 and clamping members 41′, 42′ and 43′ which are all constructed in the same manner as the clamping members 41′, 42 and 43. Further, by making use of a pump 65, the plating solution 10 stored in the main tank 23 is introduced, through an inlet passageway 66 and an inlet port 75 formed in the holding plate 74, into the cylinder 1 directly from the bottom opening side of the cylinder 1 without employing the subtank 32, the plating solution 10 being subsequently discharged from the plug-mounting hole 18 into a discharging passageway 82 having a flow rate-adjusting valve 80 attached thereto, thus allowing the plating solution 10 to return to the main tank 23.

In the case of the plating method and the plating apparatus of this embodiment, when the opening degree of the flow rate-adjusting valve 80 constituting the plating solution circulating means and the operating time of the pump 65 are set in advance so as to obtain a desired thickness of non-electrolytically deposited layer, it is possible to obtain almost the same effects as those of the previous embodiment without necessitating any other manipulations (such as the manipulation of rotating the cylinder or the manipulation of agitating the plating solution).

While in the foregoing two embodiments of the present invention have been explained in details for the purpose of illustration, it will be understood that the construction of the device can be varied without departing from the spirit and scope of the invention as claimed in the following claims.

1. A method of applying metal plating to a cylinder of an internal combustion engine, the method comprising filling the cylinder with a plating solution, and then permitting the plating solution to pass through and along the axial line of the cylinder, thereby permitting a layer of electroless plating to be deposited on an inner circumferential surface of the cylinder.

2. The method according to claim 1, wherein said cylinder is held in such a manner that the axial line of said cylinder having a through-hole formed on the head portion thereof is aligned parallel with the vertical line, and the plating solution is introduced from an opening provided at the bottom of the cylinder so as to fill the cylinder with the plating solution and then, permitted to flow out of the cylinder through the through-hole.

3. The method according to claim 1 or 2, wherein a predetermined quantity of the plating solution is introduced from a main tank into a subtank disposed over the cylinder and then, the plating solution is permitted to gravitationally drop into the cylinder from the subtank, thereby filling the cylinder with the plating solution, the plating solution being subsequently permitted to pass through the interior of the cylinder and to return to the main tank.

4. The method according to claim 1 or 2, wherein the plating solution stored in a tank is pumped up by means of a pump and directly introduced into the cylinder, thereby filling the cylinder with the plating solution, the plating solution being subsequently permitted to pass through the interior of the cylinder and to return to said main tank.

5. The method according to claim 1, wherein said electroless plating solution is formed of a nickel (Ni)-phosphorus (P)-boron (B)-based plating solution.

6. A plating apparatus which is designed to apply electroless plating to the inner circumferential surface of a cylinder of internal combustion engine, the cylinder having a through-hole at the head portion thereof; wherein said plating apparatus comprises:
a clamping means for holding the cylinder in a predetermined posture;
a plating solution-introducing means for introducing a plating solution into the cylinder; and
a plating solution-circulating means for filling the interior of the cylinder with the plating solution introduced by the plating solution-introducing means while enabling the plating solution to pass through the interior of the cylinder at a predetermined flow rate.

7. The plating apparatus according to claim 6, wherein said clamping means is designed to hold the cylinder in such a manner that the axial line of the cylinder is aligned parallel with the vertical line.

8. The plating apparatus according to claim 6, wherein said plating solution-introducing means is provided with a subtank which is disposed over the cylinder and designed to temporarily store the plating solution.

9. The plating apparatus according to claim 6, wherein said plating solution-introducing means is provided with a pump for directly introducing the plating solution into the cylinder.

10. The plating apparatus according to claim 6, wherein said plating solution-circulating means comprises a flow rate-adjusting nozzle which is disposed so as to plug said through-hole.

11. The plating apparatus according to claim 9, wherein said plating solution-circulating means comprises a flow rate-adjusting valve which is designed to adjust the flow rate of the plating solution which is being discharged out of the cylinder after passing through the interior of the cylinder.

12. The plating apparatus according to claim 6, further comprising a cap member for closing an outer opening of an inlet port formed in an inner circumferential surface or a piston-sliding surface of the cylinder and also with a cap member for closing an outer opening of an exhaust port formed in the inner circumferential surface of the cylinder.

13. The plating apparatus according to claim 12, wherein said cap members are respectively provided with a flow rate-adjusting hole for permitting the plating solution to flow out of the cylinder through the inlet port and/or exhaust port.

14. The plating apparatus according to claim 6, further comprising heating means for heating the cylinder as well as the plating solution up to a predetermined working temperature.
